(19) United States
(12) Patent Application Publication
(10) Pub. No.: US 2012/0170572 A1
(43) Pub. Date: Jul. 5, 2012

(54) Method for Enhancing Phone Conversations

(75) Inventors: Reuben Bareli, Herzliya (IL); Dan Shirron, Givaat Ada (IL); Eyal Toledano, Kiryat Ata (IL); No'omi Korem, Tel Aviv (IL); Dror Tirosh, Raanana (IL)

(73) Assignee: SAMSUNG ELECTRONICS CO., LTD., Gyeonggi-do (KR)

(21) Appl. No.: 12/983,341

(22) Filed: Jan. 3, 2011

(51) Int. Cl. H04L 12/66

(52) U.S. Cl. 370/352

(57) ABSTRACT

A method for enhancing voice conversations comprises providing a server interacting with two or more communication devices which carry out a voice communication, said communication devices being provided with software to simultaneously establish a TCP/IP connection between them, which is mediated by said server.

### FIELD OF THE INVENTION

The present invention relates to the field of communications. More particularly, the invention relates to a method for enhancing phone conversations.

### BACKGROUND OF THE INVENTION

Users seek communication means that will satisfy their social interaction and communication needs. The social interaction complexity and rising from modern and advanced environments requires constantly improving interaction capabilities and additional input and output methods supporting richer media. According to the present art that is a limitation as to the extent of interaction that can be accomplished using a mobile communication device, such as a cellular phone. Currently during a phone call a user is limited to transferring voice or video communication. When users want to share files during a phone call (e.g. images), they normally switch to other communication channel (e.g. the Internet).

Attempts have been made in the art to provide partial solutions to these emerging needs. For instance, cellular phones exist, which enable the transfer of SMS or MMS during a phone call. This feature, however, does not provide for the synchronization between the data channel and the voice call. For example, if the user wants to transfer an image and talk about it simultaneously, he will send an MMS, but the MMS may not be transferred to the recipient in time useful for the purposes of the conversation, and furthermore the sender will not be notified once the MMS is delivered to the recipient's phone.

Other cellular phones enable the presentation of media files during a video call. However, this method has the severe drawback that the quality of the transferred media is limited to the quality of the video call (which is low). Also the transferable media type is limited to video, image and sound (i.e., it can't send location information).

Another option is to send media through Internet services, such as e-mail or instant messengers. However, this option involves a cumbersome user interface (UI) usage, because of the need to switch to a different application during the phone call. Furthermore a new different connection has to be established (e.g. acquiring the email address of the call partner).

Some cellular phones allow the use of standard protocols (e.g. DLNA, uPnP) for the utilization of available consumer electronics (CE) for media rendering, media storage, media control, etc. However, this solution also involves a cumbersome UI usage, because of the need to switch to a different application during the phone call. Attempts have been made in the art to enrich cellular phone calls. For instance, the so-called “Rich Communication Suit” (RCS) (http://www.gsmworld.com/our-work/mobile_lifestyle/res/index.htm) suggests using an enhanced address book, which contains details of users who can exchange rich content. This method, however, presents severe limitations inasmuch as it does not allow the exchange of rich content, such as files, between users who are not listed in the respective address books. Moreover, RCS requires carrier support for its specific protocol, which again imposes limitations to the implementation and usefulness of the method.

U.S. Patent Application No. 2009/0143007 relates to the transfer of files over the communication channel in which a voice call is taking place. Besides the problems associated with selecting files to be transferred in this way and the resulting potential bandwidth problems, file transfer can only take place as long as the communication is active.

It is therefore clear that it would be highly desirable to provide a method that will enable the sharing and collaboration of media, before, or during a phone call, which does not require the support of a carrier for a special protocol, which does not require as a precondition that the persons effecting the transfer be known and included in the respective address books beforehand, and which allows the transfer to take place also when the cellular phone call is no longer active.

Furthermore, it is the purpose of the invention to enable a privacy-based interaction between the parties whereby, using phone numbers as a basis only, the parties can exchange all sorts of media/data through various CEs.

All these are objectives which the art has so far failed to provide. It is a purpose of the present invention to provide a method that obviates the drawbacks of the prior art, which can be conveniently and easily exploited by mobile communication device users, without the need for additional and external hardware.

It is another purpose of the invention to provide such a method that, in addition, will make the log and data exchanged during the communication available after the call.

It is a further object of the invention to provide a method which allows the utilization of available CE devices, such as TV set, PCs, etc., for media rendering, media storage and media control, during and after a phone conversation enhanced according to the invention.

Other objects and advantages of the invention will become apparent as this description proceeds.

### SUMMARY OF THE INVENTION

The invention relates to a method for enhancing voice conversations, comprising providing a server interacting with two or more communication devices which carry out a voice communication, said communication devices being provided with software to simultaneously establish a TCP/IP connection between them, which is mediated by said server.

In one embodiment of the invention additional IP-enabled consumer electronics are provided with software suitable to enhance a phone conversation between the communication devices and to receive/transmit media from/to one user to another or to control the flow of data between the phones and CE devices.

In one embodiment of the invention at least one of the communication devices is a mobile communication device, such as a cellular phone.

The invention also encompasses a system for enhancing phone conversations, comprising a server suitable to interact with two or more communication devices which carry out a voice communication, and communication devices provided with software suitable to simultaneously establish a TCP/IP connection between them, which is mediated by said server.

In one embodiment of the invention the system further comprises IP-enabled consumer electronics provided with software suitable to listen in the conversation between the communication devices and to receive media transmitted from one user to another.

### BRIEF DESCRIPTION OF THE DRAWINGS

In the drawings:

FIG. 1 is a schematic illustration of the operation of a system according to one embodiment of the invention;

FIG. 2 is a flowchart that describes the user interface and the process taking place during the call initialization of a sample cellular phone;

FIG. 3 is a flowchart that describes the user interface and the process taking place during the transfer of a sample media during a phone call; and

FIG. 4 is a flowchart that describes the user interface and the process taking place during a call termination.

### DETAILED DESCRIPTION OF THE INVENTION

The invention provides a system that enables the simultaneous usage of known communication facilities of a phone before a call (during ring), during a call and after a call, through enhanced usability and data connection. Throughout this specification the cellular phone is used to exemplify the invention for the sake of simplicity, it being understood that invention extends to all kinds of mobile and non-mobile communication devices and is in no way intended to be limited to any specific communication device.

The invention provides users with a rich interaction sharing and media transfer environment before, during and after a phone conversation with minimal interruption. It empowers the users to seize opportunity during call time to maximize the social sharing and interaction experience. It enhances user's multi-tasking during call, and makes the best possible use of the call time (thus enhancing productivity). The invention further enables selecting other CE devices (e.g. TV sets or PCs) for media presentation, storage or control. It permits to perform all the above without stopping the conversation. The invention therefore provides a synchronous real-time element.

The invention can be exploited in a variety of situations to greatly improve productivity of the users, for instance:
1) Before a call—the call initiator can send data which will be used as context for the call. For example sending a visiting card that will be displayed on the phone screen of the receiving side while the phone is ringing.
2) During a call—sending data relevant to the call. For example, user “A” tells user “B” about a trip he had during the weekend and sends relevant pictures.
3) After a call—a user can use the call log to reach all media that was sent during the call.

The system according to the invention consists of the following elements:
1. Software running on the mobile device, which replaces the existing call application.
2. A server that provides user management and connectivity services.
3. Optionally, software running on CE devices or using standard media sharing protocols.
4. IP based data connection between all devices participating in the conversation (e.g., phone, CE.)

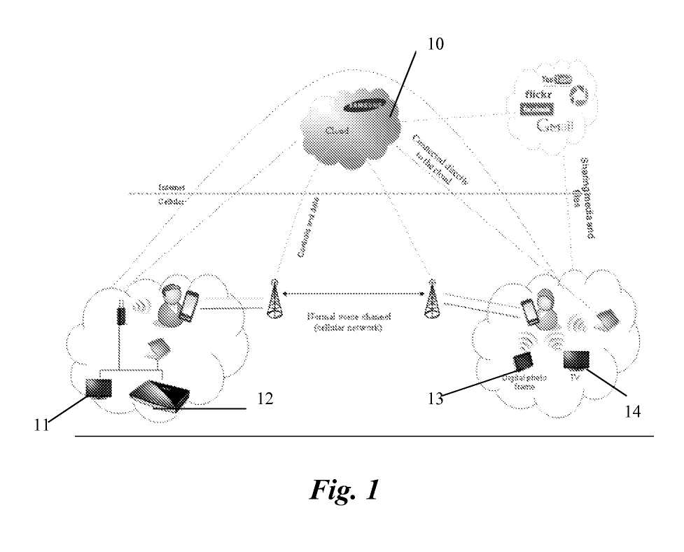

Turning now to FIG. 1, the system according to one embodiment of the invention is schematically shown. It consists of:
Communication using a Cloud Service 10—supporting live links, files and media transfer;
Extending classic phone conversation into surrounding CE devices 11, 12, 13 and 14, which enhances data sharing and collaboration between the call parties;
Remote UI mode (simplex/duplex) for controlling media;

The surrounding CE devices (12-14) are aware that a phone conversation is in place and act in context aware fashion. Hence, for example, once the system recognizes an incoming phone call all the connected devices receive an indication of that fact. At this point, each device presents a GUI that provides to the user an active way to exploit the said CE for the purpose of enhancing the conversation.

Notwithstanding the above, the system also enables the use of surrounding CEs, which use standard media sharing protocols, yet do not contain the above software. In this instance, the said CE device will only be used in a limited manner unaware of the incoming call, for the presentation or storage/retrieval of media.

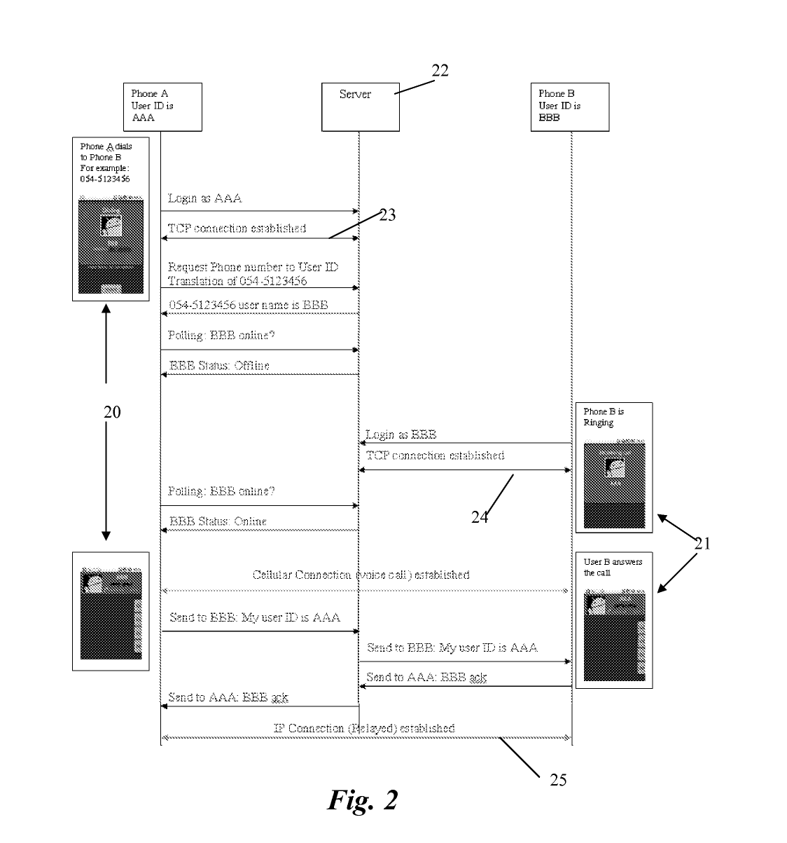

FIG. 2 is a flowchart that describes the user interface and the process taking place during the call initialization of a sample cellular phone. The left-hand side of the figure shows the activities taking place in “Phone A” (indicated by numeral 20), which initiates the conversation, and the right-hand side of the figure shows the activity taking place in “Phone B” (indicated by numeral 21), which is the phone that is receiving the call. A Server 22 interfaces with both phones.

When Phone A initiates the call it first logs in to the Server and establishes a TCP connection 23. The connection is then established and Phone B also logs in to the Server and establishes TCP connection 24. At the end of the process described in FIG. 1 both TCP connection and an IP connection 25 are established.

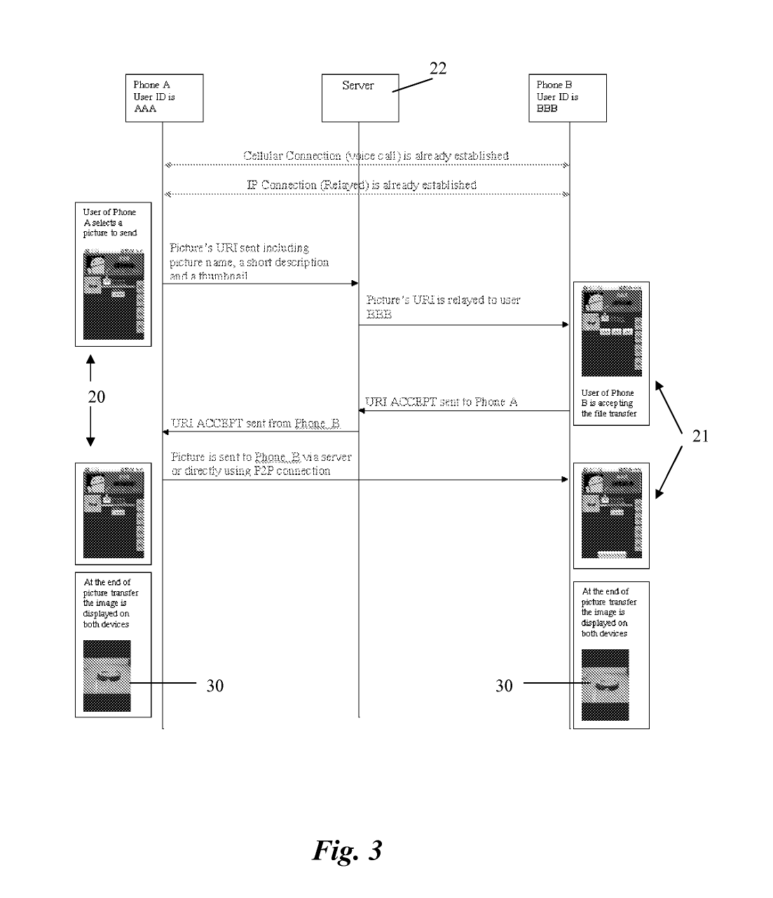

FIG. 3 illustrates a sample media transfer. The user of Phone A selects a picture 30 to transfer to the user of Phone B. This happens when the voice call is already ongoing and IP connection is already established. At this point Phone A sends the picture's data including: a title, thumbnail, description and Uniform Resource Identifier (URI) to Phone B. If Phone B chooses to accept the file it sends to Phone A a request to fetch the image using the URI as an identifier. At this point the picture is sent to Phone B either using the Server 22, or directly using a peer-to-peer connection. Such file transfer can be based for example on XMPP extensions for file transfer.

Another example of media transfer can be a chat. For example, the user of Phone A writes a short message to transfer to the user of Phone B. This happens when the voice call is already ongoing and an IP connection is already established. At this point Phone A sends the message to Phone B. This can be done for example by the messaging capability of the XMPP protocol. When phone B receives the message it displays it on the screen.

Yet, another example of media transfer is the sharing of contact information. In this example the user of Phone A presses the button of contact sharing. The address book of phone A is displayed on its screen and the user selects which contact to share. This happens when the voice call is already ongoing and the IP connection is already established. At this point Phone A sends a message to Phone B including all the data of the selected contact. This can be done for example by the messaging capability of the XMPP protocol. When phone B receives the message it displays a message to the screen including primary details of the contact, such as name and image thumbnail, and asks the user whether to add this contact to his phone book. If the user of phone B chooses to add it all the details of the contact are parsed from the message received and added to the contact list.

One more use case of the system is to continuously exchange data between the devices. This is the case when the phone users want to exchange their location in such a way that they both see in real time the location of the other. For example user of Phone A presses a button to share his location. This happens when the voice call is already ongoing and the IP connection is already established. Phone A will send a message to Phone B to allow location sharing capability. Once Phone B receives the message, another message will appear on screen and ask user of Phone B to allow this feature. When user B accepts the message, his phone will start sending periodically to Phone A a message containing its location based on the capabilities of the phone. The phone view will turn to a map centered on the location of its user. In addition to the phone's location the message may also contain data on the current view of the map including zoom level and location. When Phone A receives the message it will also turn to the map view mode, displaying the map the same way it is displayed on Phone B using the zoom level and location data retrieved from the message. Each user can use the GUI to move map, zoom or jump to the other party's location. In such an event the user will also send a message to the other side including the updated location and zoom level info to allow the update of the other side. The actual message send and receive mechanisms can be based, e.g., on the XMPP protocol.

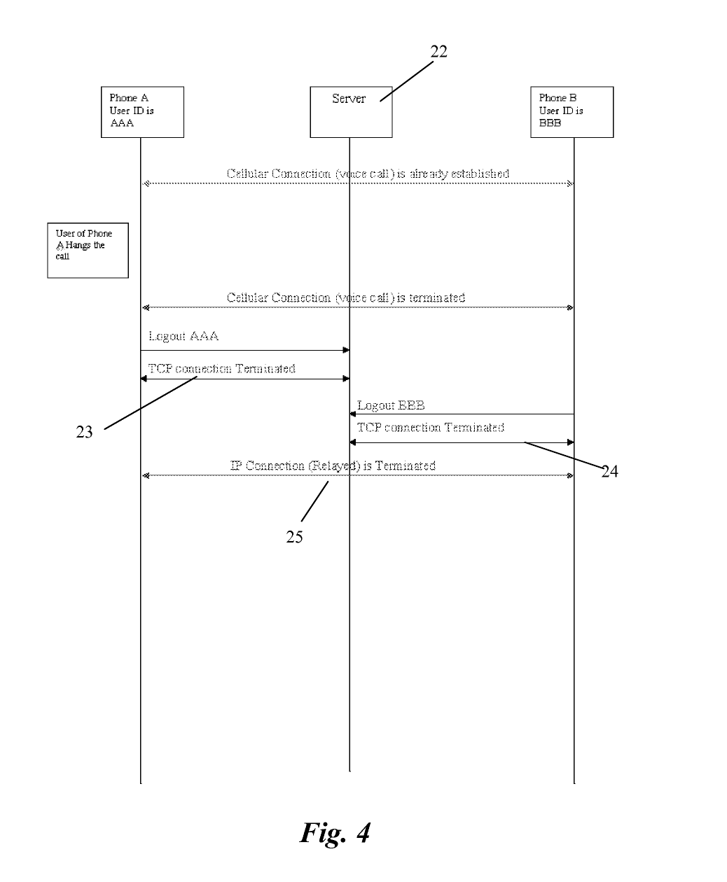

FIG. 4 illustrates the termination of a call. In this example the user of Phone A hangs up, which causes him to log out from the Server, thus terminating the TCP connection 23. Once the cellular connection is terminated Phone B also logs out and terminates the TCP connection 24 with the Server 22, at which time the IP connection 25 is also terminated. As will be apparent to the skilled person, the invention presents additional useful advantages. For instance, it is possible to create a rich log of the conversation, including the rich content exchanged. Furthermore, it is possible to display the rich content on any DLNA-enabled device, such as a TV set. The skilled person will easily appreciate the many other advantages and possibilities offered by the invention.

The above description and examples have been given for the purpose of illustration and are not intended to limit the invention in any way. Many different types of rich media can be transmitted, using different communication devices and utilizing a variety of consumer electronics, all without exceeding the scope of the invention.

1. A method for enhancing voice conversations, comprising providing a server interacting with two or more communication devices which carry out a voice communication, said communication devices being provided with software to simultaneously establish a TCP/IP connection between them, which is mediated by said server.

2. A method according to claim 1, wherein additional IP-enabled consumer electronics are provided with software suitable to enhance a phone conversation between the communication devices and to receive/transmit media from/to one user to another or to control the flow of data between the phones and CE devices.

3. A method according to claim 1, wherein at least one of the communication devices is a mobile communication device.

4. A method according to claim 3, wherein the mobile communication device is a cellular phone.

5. A system for enhancing phone conversations, comprising a server suitable to interact with two or more communication devices which carry out a voice communication, and communication devices provided with software suitable to simultaneously establish a TCP/IP connection between them, which is mediated by said server.

6. A system according to claim 5, further comprising IP-enabled consumer electronics provided with software suitable to listen in the conversation between the communication devices and to receive media transmitted from one user to another.
